(19) United States
(12) Patent Application Publication
(10) Pub. No.: US 2025/0227467 A1
(43) Pub. Date: Jul. 10, 2025

(54) COMMUNICATING AND STORING AERIAL SYSTEM SECURITY INFORMATION

(71) Applicant: LENOVO INTERNATIONAL COÖPERATIEF U.A., Amsterdam (NL)

(72) Inventors: Sheeba Backia Mary Baskaran, Friedrichsdorf (DE); Dimitrios Karampatsis, Ruislip (GB); Roozbeh Atarius, La Jolla, CA (US); Andreas Kunz, Ladenburg (DE)

(21) Appl. No.: 18/705,342

(22) PCT Filed: Dec. 2, 2021
(86) PCT No.: PCT/EP2021/084068

§ 371 Date: Apr. 26, 2024

(30) Foreign Application Priority Data
Oct. 26, 2021 (GR) 20210100735

(51) Int. Cl. H04W 12/06; H04W 12/72; H04W 48/16; H04W 84/06

(52) U.S. Cl. CPC H04W 12/06; H04W 12/72; H04W 48/16; H04W 84/06

(57) ABSTRACT

Apparatuses, methods, and systems are disclosed for communicating and storing aerial system security information. One method includes transmitting a request message to an uncrewed aerial system network function, a network exposure function, or a combination thereof, the request message including: an aerial vehicle identifier; a general public subscription identifier; and session security information. The method includes receiving a response message from the uncrewed aerial system network function, the network exposure function, or the combination thereof, the response message including: the aerial vehicle identifier; the general public subscription identifier; an aerial vehicle authentication result; and aerial system session security requirement information. The method includes storing the aerial system session security requirement information together with the aerial vehicle identifier, the general public subscription identifier, and the aerial vehicle authentication result.

### FIELD

The subject matter disclosed herein relates generally to wireless communications and more particularly relates to communicating and storing aerial system security information.

### BACKGROUND

In certain wireless communications networks, different network devices may add complexity and/or delay to a system. In such networks, network devices may not support integrity protection which may impact security.

### BRIEF SUMMARY

Methods for communicating and storing aerial system security information are disclosed. Apparatuses and systems also perform the functions of the methods. One embodiment of a method includes transmitting, from a session management function, a request message to an uncrewed aerial system network function, a network exposure function, or a combination thereof, the request message including: an aerial vehicle identifier; a general public subscription identifier; and session security information. In some embodiments, the method includes receiving a response message from the uncrewed aerial system network function, the network exposure function, or the combination thereof, the response message including: the aerial vehicle identifier; the general public subscription identifier; an aerial vehicle authentication result; and aerial system session security requirement information. In certain embodiments, the method includes storing the aerial system session security requirement information together with the aerial vehicle identifier, the general public subscription identifier, and the aerial vehicle authentication result.

One apparatus for communicating and storing aerial system security information includes a session management function. In some embodiments, the apparatus includes a transmitter that transmits a request message to an uncrewed aerial system network function, a network exposure function, or a combination thereof, the request message including: an aerial vehicle identifier; a general public subscription identifier; and session security information. In various embodiments, the apparatus includes a receiver that receives a response message from the uncrewed aerial system network function, the network exposure function, or the combination thereof, the response message including: the aerial vehicle identifier; the general public subscription identifier; an aerial vehicle authentication result; and aerial system session security requirement information. In certain embodiments, the apparatus includes a processor that stores the aerial system session security requirement information together with the aerial vehicle identifier, the general public subscription identifier, and the aerial vehicle authentication result.

Another embodiment of a method for communicating and storing aerial system security information includes receiving, at an uncrewed aerial system network function, a network exposure function, or a combination thereof, a first request message from a session management function, the first request message including: an aerial vehicle identifier; a general public subscription identifier; and session security information. In some embodiments, the method includes transmitting a second request message to an uncrewed aerial system service supplier, an uncrewed aerial system traffic management function, or a combination thereof, the second request message including: the aerial vehicle identifier; the general public subscription identifier; and the session security information. In certain embodiments, the method includes receiving a second response message from the uncrewed aerial system service supplier, the uncrewed aerial system traffic management function, or the combination thereof, the second response message including: the aerial vehicle identifier; the general public subscription identifier; an aerial vehicle authentication result; and aerial system session security requirement information. In various embodiments, the method includes transmitting a first response message to the session management function the first response message including: the aerial vehicle identifier; the general public subscription identifier; the aerial vehicle authentication result; and the aerial system session security requirement information. In some embodiments, the method includes storing the aerial system session security requirement information together with the aerial vehicle identifier, the general public subscription identifier, and the aerial vehicle authentication result.

Another apparatus for communicating and storing aerial system security information includes an uncrewed aerial system network function, a network exposure function, or a combination thereof. In some embodiments, the apparatus includes a receiver that receives a first request message from a session management function, the first request message including: an aerial vehicle identifier; a general public subscription identifier; and session security information. In various embodiments, the apparatus includes a transmitter that transmits a second request message to an uncrewed aerial system service supplier, an uncrewed aerial system traffic management function, or a combination thereof, the second request message including: the aerial vehicle identifier; the general public subscription identifier; and the session security information. In certain embodiments, the apparatus includes a processor, wherein: the receiver receives a second response message from the uncrewed aerial system service supplier, the uncrewed aerial system traffic management function, or the combination thereof, the second response message including: the aerial vehicle identifier; the general public subscription identifier; an aerial vehicle authentication result; and aerial system session security requirement information; the transmitter transmits a first response message to the session management function the first response message including: the aerial vehicle identifier; the general public subscription identifier; the aerial vehicle authentication result; and the aerial system session security requirement information; and the processor stores the aerial system session security requirement information together with the aerial vehicle identifier, the general public subscription identifier, and the aerial vehicle authentication result.

A further embodiment of a method for communicating and storing aerial system security information includes receiving, at an uncrewed aerial system service supplier, an uncrewed aerial system traffic management function, or a combination thereof, a request message from an uncrewed aerial system network function, a network exposure function, or a combination thereof, the request message including: an aerial vehicle identifier; a general public subscription identifier; and session security information. In some embodiments, the method includes performing authentication, authorization, or a combination thereof of an aerial vehicle corresponding to the aerial vehicle identifier. In certain embodiments, the method includes determining aerial system session security requirement information based on the session security information. In various embodiments, the method includes storing the aerial system session security requirement information together with the aerial vehicle identifier, the general public subscription identifier, and an aerial vehicle authentication result. In some embodiments, the method includes transmitting a response message to the uncrewed aerial system network function, the network exposure function, or the combination thereof, the response message including: the aerial vehicle identifier; the general public subscription identifier; and the aerial system session security requirement information.

A further apparatus for communicating and storing aerial system security information includes an uncrewed aerial system service supplier, an uncrewed aerial system traffic management function, or a combination thereof. In some embodiments, the apparatus includes a receiver that receives a request message from an uncrewed aerial system network function, a network exposure function, or a combination thereof, the request message including: an aerial vehicle identifier; a general public subscription identifier; and session security information. In various embodiments, the apparatus includes a processor that: performs authentication, authorization, or a combination thereof of an aerial vehicle corresponding to the aerial vehicle identifier; determines aerial system session security requirement information based on the session security information; and stores the aerial system session security requirement information together with the aerial vehicle identifier, the general public subscription identifier, and an aerial vehicle authentication result. In certain embodiments, the apparatus includes a transmitter that transmits a response message to the uncrewed aerial system network function, the network exposure function, or the combination thereof, the response message including: the aerial vehicle identifier; the general public subscription identifier; and the aerial system session security requirement information.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for communicating and storing aerial system security information;

FIG. 2 is a schematic block diagram illustrating one embodiment of an apparatus that may be used for communicating and storing aerial system security information;

FIG. 3 is a schematic block diagram illustrating one embodiment of an apparatus that may be used for communicating and storing aerial system security information;

FIG. 4 is a schematic block diagram illustrating one embodiment of a system for service based use plane security policy enforcement for UAS related PDU session establishment and/or modification;

FIG. 5 is a schematic block diagram illustrating one embodiment of a system for user plane security enforcement during PDN connection establishment and/or modification;

FIG. 6 is a flow chart diagram illustrating one embodiment of a method for communicating and storing aerial system security information;

FIG. 7 is a flow chart diagram illustrating another embodiment of a method for communicating and storing aerial system security information; and

FIG. 8 is a flow chart diagram illustrating a further embodiment of a method for communicating and storing aerial system security information.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

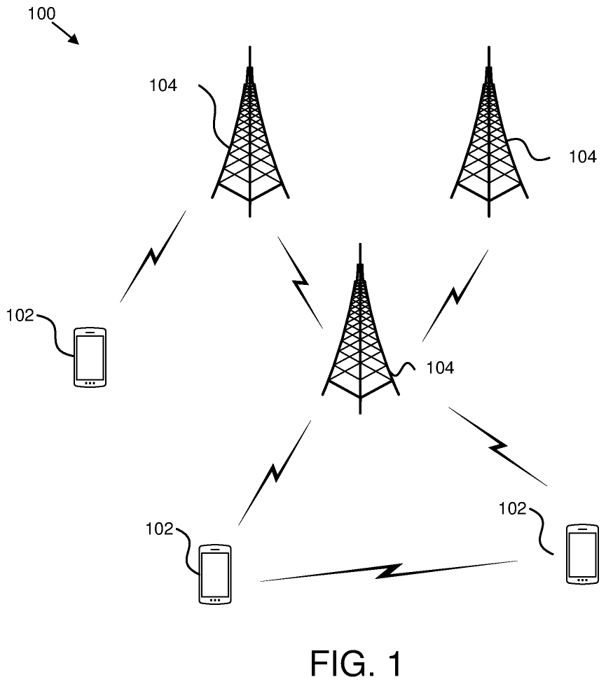

FIG. 1 depicts an embodiment of a wireless communication system 100 for communicating and storing aerial system security information. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), a Uncrewed Aerial System Network Function (“UAS NF”), an Network Exposure Function (“NEF”), a UAS Service Supplier (“USS”), a Uncrewed Aerial System Traffic Management (“UTM”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a network unit 104 may transmit a request message to an uncrewed aerial system network function, a network exposure function, or a combination thereof, the request message including: an aerial vehicle identifier; a general public subscription identifier; and session security information. In some embodiments, the network unit 104 may receive a response message from the uncrewed aerial system network function, the network exposure function, or the combination thereof, the response message including: the aerial vehicle identifier; the general public subscription identifier; an aerial vehicle authentication result; and aerial system session security requirement information. In certain embodiments, the network unit 104 may store the aerial system session security requirement information together with the aerial vehicle identifier, the general public subscription identifier, and the aerial vehicle authentication result. Accordingly, the network unit 104 may be used for communicating and storing aerial system security information.

In certain embodiments, a network unit 104 may receive a first request message from a session management function, the first request message including: an aerial vehicle identifier; a general public subscription identifier; and session security information. In some embodiments, the network unit 104 may transmit a second request message to an uncrewed aerial system service supplier, an uncrewed aerial system traffic management function, or a combination thereof, the second request message including: the aerial vehicle identifier; the general public subscription identifier; and the session security information. In certain embodiments, the network unit 104 may receive a second response message from the uncrewed aerial system service supplier, the uncrewed aerial system traffic management function, or the combination thereof, the second response message including: the aerial vehicle identifier; the general public subscription identifier; an aerial vehicle authentication result; and aerial system session security requirement information. In various embodiments, the network unit 104 may transmit a first response message to the session management function the first response message including: the aerial vehicle identifier; the general public subscription identifier; the aerial vehicle authentication result; and the aerial system session security requirement information. In some embodiments, the network unit 104 may store the aerial system session security requirement information together with the aerial vehicle identifier, the general public subscription identifier, and the aerial vehicle authentication result. Accordingly, the network unit 104 may be used for communicating and storing aerial system security information.

In some embodiments, a network unit 104 may receive an uncrewed aerial system traffic management function, or a combination thereof, a request message from an uncrewed aerial system network function, a network exposure function, or a combination thereof, the request message including: an aerial vehicle identifier; a general public subscription identifier; and session security information. In some embodiments, the network unit 104 may perform authentication, authorization, or a combination thereof of an aerial vehicle corresponding to the aerial vehicle identifier. In certain embodiments, the network unit 104 may determine aerial system session security requirement information based on the session security information. In various embodiments, the network unit 104 may store the aerial system session security requirement information together with the aerial vehicle identifier, the general public subscription identifier, and an aerial vehicle authentication result. In some embodiments, the network unit 104 may transmit a response message to the uncrewed aerial system network function, the network exposure function, or the combination thereof, the response message including: the aerial vehicle identifier; the general public subscription identifier; and the aerial system session security requirement information. Accordingly, the network unit 104 may be used for communicating and storing aerial system security information.

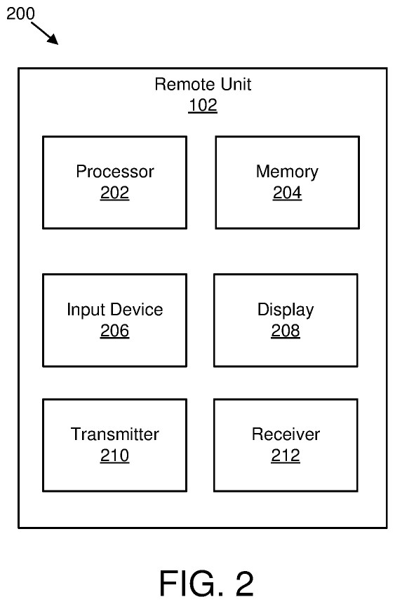

FIG. 2 depicts one embodiment of an apparatus 200 that may be used for communicating and storing aerial system security information. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

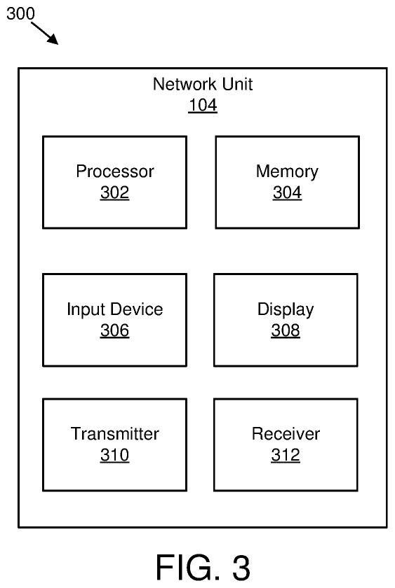

FIG. 3 depicts one embodiment of an apparatus 300 that may be used for communicating and storing aerial system security information. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the transmitter 310 transmits a request message to an uncrewed aerial system network function, a network exposure function, or a combination thereof, the request message including: an aerial vehicle identifier; a general public subscription identifier; and session security information. In various embodiments, the receiver 312 receives a response message from the uncrewed aerial system network function, the network exposure function, or the combination thereof, the response message including: the aerial vehicle identifier; the general public subscription identifier; an aerial vehicle authentication result; and aerial system session security requirement information. In certain embodiments, the processor 302 stores the aerial system session security requirement information together with the aerial vehicle identifier, the general public subscription identifier, and the aerial vehicle authentication result.

In some embodiments, the receiver 312 receives a first request message from a session management function, the first request message including: an aerial vehicle identifier; a general public subscription identifier; and session security information. In various embodiments, the transmitter 310 transmits a second request message to an uncrewed aerial system service supplier, an uncrewed aerial system traffic management function, or a combination thereof, the second request message including: the aerial vehicle identifier; the general public subscription identifier; and the session security information. In certain embodiments, the receiver 312 receives a second response message from the uncrewed aerial system service supplier, the uncrewed aerial system traffic management function, or the combination thereof, the second response message including: the aerial vehicle identifier; the general public subscription identifier; an aerial vehicle authentication result; and aerial system session security requirement information; the transmitter 310 transmits a first response message to the session management function the first response message including: the aerial vehicle identifier; the general public subscription identifier; the aerial vehicle authentication result; and the aerial system session security requirement information; and the processor 302 stores the aerial system session security requirement information together with the aerial vehicle identifier, the general public subscription identifier, and the aerial vehicle authentication result.

In various embodiments, the receiver 312 receives a request message from an uncrewed aerial system network function, a network exposure function, or a combination thereof, the request message including: an aerial vehicle identifier; a general public subscription identifier; and session security information. In various embodiments, the processor 302: performs authentication, authorization, or a combination thereof of an aerial vehicle corresponding to the aerial vehicle identifier; determines aerial system session security requirement information based on the session security information; and stores the aerial system session security requirement information together with the aerial vehicle identifier, the general public subscription identifier, and an aerial vehicle authentication result. In certain embodiments, the transmitter 310 transmits a response message to the uncrewed aerial system network function, the network exposure function, or the combination thereof, the response message including: the aerial vehicle identifier; the general public subscription identifier; and the aerial system session security requirement information.

In certain embodiments, a uncrewed aerial system (“UAS”) service supplier (“USS”) and/or uncrewed aerial system traffic management (“UTM”) may or may not provide end-to-end security to UAS communication and it may not be visible and/or known to a fifth generation (“5G”) system (“5GS”) and/or evolved packet system (“EPS”). In some embodiments, there may be issues with a user plane (“UP”) security enforcement related to the UAS services including: 1) if the USS and/or UTM applies end-to-end security for the UAS service application data, then applying an additional user plane security at the physical data convergence protocol (“PDCP”) layer in 5GS may add complexity and delay to the time-sensitive application such as a UAS service; and 2) the UAS communication may be supported over EPS, but the EPS may not support integrity protection to the user plane data. So, if the USS and/or UTM does not apply end-to-end security for the UAS communication, then it may result in critical security impacts to user plane data and the related service-command and control (“C2”) messages and service data may be included in UAS connectivity communications over the EPS leading to uncrewed aerial vehicle (“UAV”) hijack and other issues.

In various embodiments, user plane data protection information may be coordinated between a 3GPP network and a third-party service provider (e.g., such as a USS and/or UTM for UAS communication) to ensure user plane security enforcement for UAS related data. In certain embodiments, a complexity and delay in 5G system due to applying multiple user plane security over a single user plane data may be reduced by enabling only one user plane security approach to be used (e.g., either hop-by-hop security or end-to-end security). In some embodiment, another user plane security may be applied for a UAS communication and/or C2 data by a USS and/or UTM even if the user plane security (e.g., confidentiality and/or integrity) is not supported and/or offered by the EPS.

In a first embodiment, there may be service based user plane security enforcement in 3GPP 5GS. Specifically, in the first embodiment, the 5G system may negotiate and inform a USS and/or UTM if a session security for a user plane will be applied or not by the 5GS during a protocol data unit (“PDU”) session establishment and/or modification procedure. This may enable the USS and/or UTM to activate the end-to-end security if a user plane security may not be applied by the 5GS. In certain embodiments, a USS and/or UTM may skip end-to-end security if the user plane security will be applied by the 5GS.

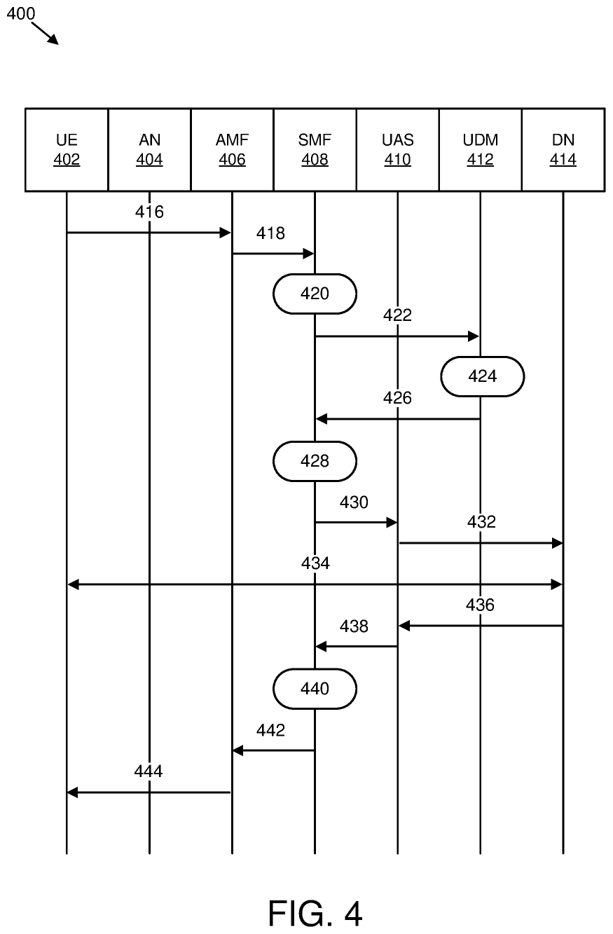

FIG. 4 is a schematic block diagram illustrating one embodiment of a system 400 for service based use plane security policy enforcement for UAS related PDU session establishment and/or modification. The system 400 includes a user equipment (“UE”) 402 (e.g., UAV), an access network (“AN”) 404 (e.g., radio access network (“RAN”)), an AMF 406, an SMF 408, a UAS 410 (e.g., UAS network function (“NF”) and/or network exposure function (“NEF”)), a UDM 412, and a data network (“DN”) 414 (e.g., USS/UTM). It should be noted that each of the communications in the system 400 may include one or more messages.

In a first communication 416, the UE 402 sends to the AMF 406 a PDU session establishment request in a non-access stratum (“NAS”) message which includes a service level device identity (e.g., a civil aviation administration (“CAA”) level (“CAA-Level”) UAV identifier (“ID”) of a UAV) and optionally authentication data (e.g., a USS UAV authorization and/or authentication (“UUAA”) aviation payload). In various embodiments, for PDU session establishment and/or modification related to UAV and UAV controller (“UAV-C”) pairing authorization, the first communication 416 may include UAV and/or UAV-C pairing information and a C2 aviation payload.

In a second communication 418, the AMF 406 selects the SMF 408 and sends a Nsmf_PDUSession_CreateSMContext request message along with a PDU session establishment request. In certain embodiments, the AMF 406 may send a Nsmf_PDUSession_UpdateSMContext request message to the SMF 408.

In steps 420, 422, 434, and 426, if there is session management subscription data, a user plane security policy and slice for a corresponding subscription permanent identifier (“SUPI”), a data network name (“DNN”) and a single (“S”) network slice selection assistance information (“NSSAI”) (“S-NSSAI”) of a home public land mobile network (“HPLMN”) is not available, then the SMF 408 retrieves the session management subscription data along with a user plane security policy using Nudm_SDM_Get (e.g., SUPI, session management subscription data, selected DNN, S-NSSAI of the HPLMN, serving public land mobile network (“PLMN”) ID, network identifier (“NID”)) and subscribes to be notified when this subscription data is modified using Nudm_SDM_Subscribe (e.g., SUPI, session management subscription data, selected DNN, S-NSSAI of the HPLMN, serving PLMN ID, NID). The UDM 412 may get this information from a UDR by Nudr_DM_Query (e.g., SUPI, subscription data, session management subscription data, selected DNN, S-NSSAI of the HPLMN, serving PLMN ID, NID) and may subscribe to notifications from the UDR for the same data by Nudr_DM_subscribe.

In some embodiments, for the UAVs and/or UEs with aerial subscription, the UDM 412 may contain “aerial subscription user plane security policy” set as “required” in the UDR (e.g., along with the subscription data) and data key may be SUPI. In such embodiments, the UDM may provide an aerial subscription user plane security policy along with aerial subscription data to the AMF 406 and/or the SMF 408 if the subscription data is requested by the AMF 406 and/or the SMF 408. In various embodiments, if a DNN and/or an S-NSSAI are specific to a UAV, the UAS 410, and/or a C2 communication, then a user plane security policy for confidentiality and integrity protection may be set as “required”.

In certain embodiments, from the SMF 408 to the AMF 406, either Nsmf_PDUSession_CreateSMContext response (e.g., cause, session management (“SM”) context ID, or N1 SM container (PDU session reject (Cause))) or an Nsmf_PDUSession_UpdateSMContext response depending on the request received in step 418. If the SMF 408 received Nsmf_PDUSession_CreateSMContext request in step 418 and the SMF 408 is able to process a PDU session establishment request, the SMF 408 creates an SM context and responds to the AMF 406 by providing an SM context ID. If a UP security policy for the PDU session is determined to have integrity protection set to “required”, the SMF 408 may, based on a local configuration, decide whether to accept or reject a PDU session request based on a UE integrity protection maximum data rate. If the SMF 408 decides to not accept to establish a PDU session, the SMF 408 rejects the UE 402 request via NAS SM signaling including a relevant SM rejection cause by responding to the AMF 406 with a Nsmf_PDUSession_CreateSMContext response. The SMF 408 also indicates to the AMF 406 that the PDU session ID is to be considered as released, and the PDU session establishment procedure is stopped.

The SMF 408 determines 428 that it needs to invoke a UAS 410 service operation for UUAA authentication and/or authorization of the PDU session establishment request based on the provided DNN and/or S-NSSAI. The UAV includes the service level device identity (e.g., the CAA-Level UAV ID of the UAV) and may include the authentication server address (e.g., the USS address) and optionally authentication data (e.g., the UUAA aviation payload) in the PDU session establishment request. In some embodiments, for PDU session establishment and/or modification related to UAV and UAV-C pairing authorization, in step 428, the SMF 408 may determine to invoke authorization with USS and/or UTM.

In a fifth communication 430, the SMF 408 invokes an Nnef_Authentication_Authenticate service operation including the service level device identity (e.g., that contains the CAA-Level UAV ID of the UAV), session security information and/or user plane security policy, DNN, S-NSSAI, and may include the authentication server address (e.g., the USS address) and the authentication data (e.g., the UUAA aviation payload) if it was provided by the UE 402, general public subscription identifier (“GPSI”), and so forth. In various embodiments, for PDU session establishment and/or modification related to UAV and UAV-C pairing authorization, step 430 may also include UAV and/or UAV-C pairing information and a C2 aviation payload. In certain embodiments, UAS 410 session security information and/or session security information may be called “user plane security policy” and/or “external user plane security policy”.

In some embodiments, the SMF 408 includes session security information in a Nnef_Authentication_Authenticate service operation (or in any NF service operation message) based on a local configuration related to user plane security and/or user plane security policy retrieved from the UDM 412 as part of the subscription data and/or UE integrity protection maximum data rate, and/or if a UUAA is invoked, a C2 pairing authorization is invoked with the USS and/or UTM.

In various embodiments, a purpose of session security information sent from the SMF 408 is to inform the USS and/or the UTM that whether a user plane security (e.g., confidentiality and/or integrity) may be applied by the 5G system.

In certain embodiments, the SMF 408 sets a session security information and/or a user plane security policy as “supported and/or enabled” based on one or more of the following conditions: 1) whether the user plane security policy locally configured is “required”; 2) whether the user plane security policy fetched from the UDM 412 is “required”; 3) whether the UE integrity protection maximum data rate is valid to apply the user plane security; and/or 4) whether the aerial subscription user plane security policy fetched from the UDM 412 is “required”.

In some embodiments, the SMF 408 sets session security information and/or a user plane security policy as “not-supported, not preferred, and/or not required” based on one or more of the following conditions: 1) whether a user plane security policy locally configured is “not needed and/or not preferred”; 2) whether the user plane security policy fetched from the UDM 412 is “not needed and/or not preferred”; 3) whether the UE integrity protection maximum data rate is not valid to apply the user plane security; and/or 4) whether there is no aerial subscription or if it is set as “not needed and/or not preferred”.

In a sixth communication 432 from the UAS 410 to the DN 414, a Naf_Authentication_Authenticate_service operation forwarding the authentication request with session security information and/or user plane security policy received information from the SMF 408. In various embodiments, for PDU session establishment and/or modification related to UAV and UAV-C pairing authorization, step 432 may also include UAV and/or UAV-C pairing information and a C2 aviation payload.

In an optional seventh communication 434, multiple round-trip messages as required by an authentication method used by the DN 414 are performed. N33_Authentication_Authenticate response messages from the DN 414 may include GPSI and may include an authentication message that is forwarded transparently to the UE 402 over NAS mobility management (“MM”) transport messages.

In various embodiments, for PDU session establishment and/or modification related to UAV and UAV-C pairing authorization, the USS and/or UTM may perform UAV and/or UAV-C pairing authorization.

In an eighth communication 436 transmitted from the DN 414 to the UAS 410, a Naf_Authentication_Authenticate response is transmitted. Specifically, the DN 414 sends a Naf_Authentication_Authenticate response to the UAS 410 with the authentication and/or authorization result containing the UUAA result, UAS session security requirement information, a service level device identity containing a new CAA-Level UAV ID, requested policy information, and/or an authorization data (e.g., the UUAA authorization payload). The requested policy information from the DN 414 may contain a DN authorization profile index and/or a DN authorized session aggregate maximum bit rate (“AMBR”).

In certain embodiments, for PDU session establishment and/or modification related to UAV and UAV-C pairing authorization, step 436 may also contain pairing results and C2 session security requirement information. In some embodiments, UAS session security requirement information may be provided by the DN 414 in requested policy information to the UAS 410.

In various embodiments, UAS session security requirement information may be termed as C2 session security requirement information and/or user plane data security requirement information. In certain embodiments, a purpose of session security requirement information sent from the DN 412 may be to inform a NF in 5GS (e.g., SMF 408) about whether user plane security (e.g., confidentiality and/or integrity) needs to be applied by the 5G system.

In some embodiments, UAS session security requirement information may contain the following information: 1) a first case: 3GPP user plane security as “required” and a cause value indicates “end-to-end security is not applicable and/or not supported as enforced by a USS and/or a UTM”; or 2) a second case: 3GPP user plane security as “not required” and a cause value indicates “end-to-end security is applicable and/or supported as enforced by the USS and/or the UTM”.

In the first case, the USS and/or the UTM sets UAS session security requirement information as “required” based on one or more of the following conditions: 1) whether the USS and/or the UTM received session security information and/or a user plane security policy indicated as “supported” from the UAS 410 in step 432; and/or 2) whether the USS and/or the UTM determines not to apply end-to-end security for the session and/or user plane data. In various embodiments, a cause value may be sent. The cause value may indicate that end-to-end security is not applicable and/or not supported.

In the second case, the USS and/or the UTM sets UAS session security requirement information as “not required” based on one or more of the following conditions: 1) whether the USS and/or the UTM received session security information and/or user plane security policy indicated as “not needed and/or not preferred” from the UAS 410 in step 432; and/or 2) whether the USS and/or the UTM determines to apply end-to-end security for the session and/or user plane data. In certain embodiments, a cause value may be sent. The cause value may indicate that end-to-end security is applicable and/or supported.

In some embodiments, if the USS and/or the UTM received session security information and/or user plane security policy is “supported and/or enabled” from the UAS 410 in step 432, then the USS and/or the UTM may determine to skip end-to-end security and may set the UAS session security requirement information as “required” and a cause value may be set as end-to-end security is not applicable and/or not supported.

In various embodiments, if the USS and/or the UTM received session security information and/or user plane security policy is “not needed and/or not preferred” from the UAS 410 in step 432, then the USS and/or the UTM may determine to perform end-to-end security and may set the UAS session security requirement information as “not required” and a cause value may be set as end-to-end security is applicable and/or supported. In certain embodiments, an “acknowledgement” indication may be sent in UAS session security requirement information for both the first case or the second case.

In some embodiments, the DN 414 stores a mapping between the CAA-Level UAV ID and the external identifier (e.g., GPSI) along with the related UAS session security requirement information. The external identifier (e.g., GPSI) and/or UAV IP address may be used at a later point by the DN 414 for accessing various services exposed by the 3GPP network (e.g., location information retrieval, monitoring event configuration, requesting dedicated policies for C2, and so forth). The external identifier and/or UAV IP address, and UAS session security requirement information may be used at a later point by the DN 414 for requesting dedicated policies for C2 security, and so forth.

In a ninth communication 438, the UAS 410 confirms successful authentication and/or authorization of the PDU session. The UAS 410 stores the UUAA result together with the GPSI, and UAS session security requirement information. The UAS 410 forwards the authentication and/or authorization result, UAS session security requirement information a service level device identity containing the new CAA-Level UAV ID, if received from the DN 414, and the authorization data (e.g., the UUAA authorization payload), if received from the DN 414, to the SMF 408. If the authentication and/or authorization is successful, the SMF 408 subscribes for notifications from the UAS 410 which may be used to trigger re-authentication, update authorization data or revoke authorization of the UAV, upon receipt of such request from the DN 414.

In various embodiments, for PDU session establishment and/or modification related to UAV and UAV-C pairing authorization, step 438 may also contain pairing results and C2 session security requirement information.

If the SMF 408 receives UAS session security requirement information from the USS and/or the UTM via the UAS 410, then the SMF 408 stores 440 the UAS session security requirement information along with the GPSI, PDU session ID, and user plane security policy.

In certain embodiments, for PDU session establishment and/or modification related to UAV and UAV-C pairing authorization, step 440 may involve storing of pairing results and C2 session security requirement information.

In some embodiments, the SMF 408 may set the user plane security enforcement information based on the UAS session security information provided by the DN 414. In various embodiments, the SMF 408 sets the user plane security enforcement information as “required” based on whether the UAS session security requirement information is set as “required”. In certain embodiments, the SMF 408 sets the user plane security enforcement information as “not needed and/or not preferred” based on whether the UAS session security requirement information is set as “not required”.

In a tenth communication 442, the SMF 408 sends to the AMF 406, the Nsmf_PDUSession_UpdateSMContext response (e.g., N2 SM information, PDU session ID, QoS flow ID (“QFIs”), quality of service (“QoS”) profiles, core network (“CN”) N3 tunnel information, S-NSSAI, user plane security enforcement, and other information. The SMF 408 also transfers the authentication and/or authorization result, the service level device identity containing the new CAA-Level UAV ID and the authorization data (e.g., the UUAA authorization payload) to the UAV. In various embodiments, user plane security enforcement may be sent in Namf_communciation_N1N2Message transfer service operation.

In an eleventh communication 444, the AMF 406 sends to the AN 404, an N2 PDU session request with the NAS message and the AN 404 applies user plane security based on the received user plane security enforcement information. Further the AN 404 sends a PDU session accept message to the UE 402.

In certain embodiments, a 5GS may mandate user plane confidentiality and integrity protection as required (e.g., based on operator's policy) for the DNN's and/or S-NSSAIs related to UAV, UAS, and/or C2 communication (of if there is an aerial subscription for the UE) and then the NF (e.g., SMF) in 5GS may send to a USS and/or UTM via a UAS NF and/or NEF, a user plane security enabled indication to the USS and/or UTM. In such embodiments, the USS and/or the UTM receiving the user plane security enabled indication may determine to skip end-to-end security for the UAS and/or the C2 data connection.

In a second embodiment, there may be user plane security enforcement by an EPS. In the second embodiment, the EPS may ensure user plane security for UAV and/or UAS communication, even if the user plane security is not supported by the EPS by itself. In some embodiments, the EPS cannot support user plane integrity protection and user plane confidentiality is optional to be supported in the EPS. The second embodiment may enable the EPS to inform the USS and/or the UTM about a lack of user plane security support at the EPS and to request the USS and/or UTM to provide end-to-end security for the user plane related to the UAV, UAS, and/or C2 communication.

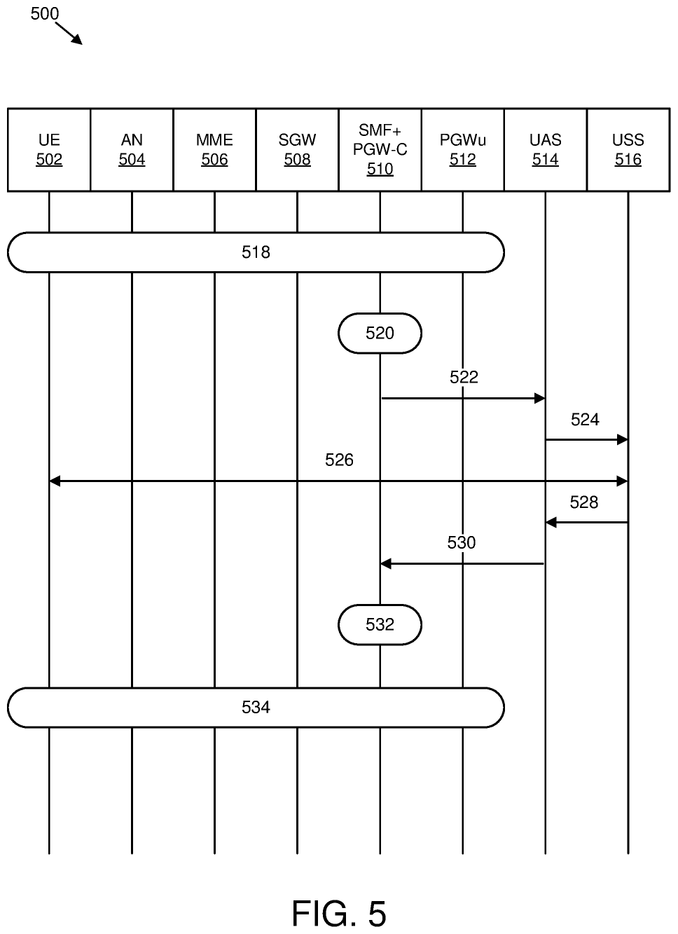

FIG. 5 is a schematic block diagram illustrating one embodiment of a system 500 for user plane security enforcement during PDN connection establishment and/or modification. The system 500 includes a UE 502 (e.g., UAV), an AN 504 (e.g., RAN), an MME 506, a serving gateway (“SGW”) 508, an SMF 510 (e.g., SMF and/or packet data network gateway (“PGW”) control (“PGW-C”), includes EPS interworking support and acts as SMF plus PGW-C), a PGW user (“PGWu”) 512 (e.g., UPF plus PGW-U), a UAS 514 (e.g., UAS NF and/or NEF), and a USS 516. It should be noted that each of the communications in the system 500 may include one or more messages.

In a first communication 518, the UE 502 initiates the attach procedure with the EPS by including a service level device identity (e.g., a CAA-Level UAV ID of the UAV), the authentication server address (e.g., the USS address), and authentication Data (e.g., the UUAA aviation payload) in the protocol configuration options (“PCO”) to the SMF 510.

In certain embodiments, the MME 506 may determine the UE 502 has an aerial subscription and selects a default APN for connectivity with the USS 516. The aerial subscription (e.g., stored in HSS and fetched from HSS by the MME 506) may also contain the user plane security policy set as “required”.

In some embodiments, the MME 506 may send the user plane security policy as “required and/or external support required” to the SMF 510 either directly or via the SGW 508 using any service-based interface related service operation message. In various embodiments, for packet data network (“PDN”) session establishment and/or modification related to UAV and UAV-C pairing authorization, step 516 may include UAV and/or UAV-C pairing information and a C2 aviation payload.

In a second communication 522, the SMF 510 invokes Nnef_Authentication_Authenticate service operation, including the service level device identity (e.g., that contains the CAA-Level UAV ID of the UAV), session security information and/or user plane security policy, DNN, S-NSSAI, and may include the authentication server address (e.g., the USS address) and the authentication data (e.g., the UUAA aviation payload) if it was provided by the UE 502, GPSI, and so forth.

In various embodiments, if the SMF 510 determines 520 to invoke UUAA with an USS and/or a UTM via the UAS 516, and/or if the SMF 510 receives a user plane security requirement policy as “required” from the MME 506 (e.g., either directly or via the SGW 508), the SMF 510 may include the session security information and/or user plane security policy in the Nnef_Authentication_Authenticate service operation.

It should be noted that the UAS session security information and/or session security information may be called “user plane security policy” and/or “external user plane security policy”. In certain embodiments, for PDN session establishment and/or modification related to UAV and UAV-C pairing authorization, step 522 can also include UAV and/or UAV-C pairing information and a C2 aviation payload.

In certain embodiments, the SMF 510 may include session security information and/or a user plane security policy in an Nnef_Authentication_Authenticate service operation (or in any NF service operation message) based on a local configuration related to user plane security and/or user plane security requirement policy retrieved from a home subscriber server (“HSS”), MME 506, and/or SGW 508 as part of the subscription data and/or aerial subscription and/or if a UUAA is invoked and/or a C2 pairing authorization is invoked with the USS 516 and/or UTM.

In some embodiments, the SMF 510 sets session security information and/or user plane security policy as “not supported, not optional, not required, and/or not enabled” based on one or more of the following conditions: 1) whether the aerial user plane security requirement policy locally configured is “required” and/or if external support is required; 2) whether the aerial user plane security requirement policy fetched from the HSS is “required” and/or external support is required; 3) whether the service is related to UAS communication; 4) whether the SMF 510 determines to invoke UUAA with the USS 516 and/or the UTM; 5) whether the SMF 510 determines to invoke C2 pairing authorization with the USS 516 and/or the UTM; and/or 6) whether the SMF 510 handles PDN connection establishment and/or modifications related to a UAV or UAS communication service.

In a third communication 524 from the UAS 514 to the USS 516, an Naf_Authentication_Authenticate_service operation forwards the authentication request with session security information and/or user plane security policy from the SMF 510.

In an optional fourth communication 526, multiple round-trip messages as required by the authentication method used by the USS 516 are performed. Authentication_Authenticate response messages from the USS 516 may include GPSI and may include an authentication message that is forwarded transparently to the UE 502 over NAS MM transport messages.

In various embodiments, for PDN session establishment and/or modification related to UAV and UAV-C pairing authorization, step 524 involves UAV and/or UAV-C pairing authorization and related message exchanges.

In a fifth communication 528 from the USS 516 to the UAS 514, an Naf_Authentication_Authenticate response is transmitted. The USS 516 sends the Naf_Authentication_Authenticate response to the UAS 514 with the authentication and/or authorization result containing the UUAA result, the UAS session security requirement information, a service level device identity containing the new CAA-Level UAV ID, requested policy information, and/or an authorization data (e.g., the UUAA authorization payload). The requested policy information from the USS may contain a DN authorization profile index and/or a DN authorized Session AMBR.

In certain embodiments, for PDN session establishment and/or modification related to UAV and UAV-C pairing authorization, step 528 may include pairing authorization results and C2 session security requirement information.

In some embodiments, UAS session security requirement information may be termed as C2 session security requirement information, session security information, and/or user plane data security requirement information. In various embodiments, UAS session security requirement information may be provided by the USS 516 in the requested policy information to the UAS 514.

In certain embodiments, the USS 516 sets the UAS session security requirement information as “not required and/or non-acknowledgement” based on one or more of the following conditions: 1) if the USS 516 and/or the UTM received session security information and/or user plane security policy is indicated as “not supported, not optional, not required, and/or not enabled” from the UAS 514 in step 528.

In some embodiments, if the USS 516 and/or the UTM determines to apply end-to-end security for the session and/or user plane data. In various embodiments, a cause value may be sent. The cause value may indicate that end-to-end security is applicable and/or supported.

In certain embodiments, the USS 516 stores a mapping between the CAA-Level UAV ID and the external identifier (e.g., GPSI) along with the related UAS session security requirement information. The external identifier (e.g., GPSI) and/or UAV internet protocol (“IP”) address may be used at a later point by the USS 516 for accessing various services exposed by a 3GPP network (e.g., location information retrieval, monitoring event configuration, requesting dedicated policies for C2, and so forth). The external identifier and/or UAV IP address, and UAS session security requirement information may be used at a later point by the USS 516 for requesting dedicated policies for C2 security, and so forth.

In a sixth communication 530, the UAS 514 confirms the successful authentication and/or authorization of the PDN connection. The UAS 514 stores the UUAA result together with the GPSI, and UAS session security requirement information. The UAS 514 forwards the authentication and/or authorization result, UAS session security requirement information, a service level device identity containing the new CAA-Level UAV ID, if received from the USS 516, and the authorization data (e.g., the UUAA authorization payload), if received from the USS 516, to the SMF 510. If the authentication and/or authorization is successful, the SMF 510 subscribes for notifications from the UAS 514 which may be used to trigger re-authentication, update authorization data or revoke authorization of the UAV, upon receipt of such request from the USS 516.

In various embodiments, for PDN session establishment and/or modification related to UAV and UAV-C pairing authorization, step 530 may include pairing authorization results and C2 session security requirement information.

The SMF 510 stores 532 the UAS session security requirement information along with the CAA level UAV ID and/or GPSI.

In certain embodiments, for PDN session establishment and/or modification related to UAV and UAV-C pairing authorization, in step 532 the SMF 510 may store pairing authorization results and C2 session security requirement information.

In a seventh communication 534, the rest of the PDN connection may be the same as in an EPS system.

In some embodiments, an access control list may be configured and may perform UUAA in PCO.

In various embodiments, the UE 502 may initiate an attach procedure with an EPS by including a service level device identity (e.g., the CAA-Level UAV ID of the UAV), the authentication server address (e.g., the USS 516 address), and authentication data (e.g., the UUAA aviation payload), and so forth in the PCO to the SMF 510.

In certain embodiments, the MME 506 may determine the UE 502 has an aerial subscription and selects the default access point name (“APN”) for connectivity with the USS 516. The aerial subscription (e.g., stored in HSS and fetched from HSS by the MME 506) may also contain the user plane security policy set as “required”.

In some embodiments, the MME 506 may send the user plane security policy as “required” to the SMF 510 either directly or via the SGW 508 using any service-based interface related service operation message.

In various embodiments, the SMF 510 may configure an access control list (“ACL”) in a UPF+PGW-U to stop any traffic over a default PDN connection.

In certain embodiments, UUAA may be invoked by the SMF 510.

In some embodiments, the PCO, including the authentication message from the USS 516, is transferred to the UE 502 by the SMF 510 in an update bearer request and downlink NAS transport. The response from the UE 502 may be transferred to the SMF 510 in an uplink NAS transport and update bearer response.

In various embodiments, the SMF 510 may store UAS session security requirement information along with a CAA level UAV ID and/or GPSI.

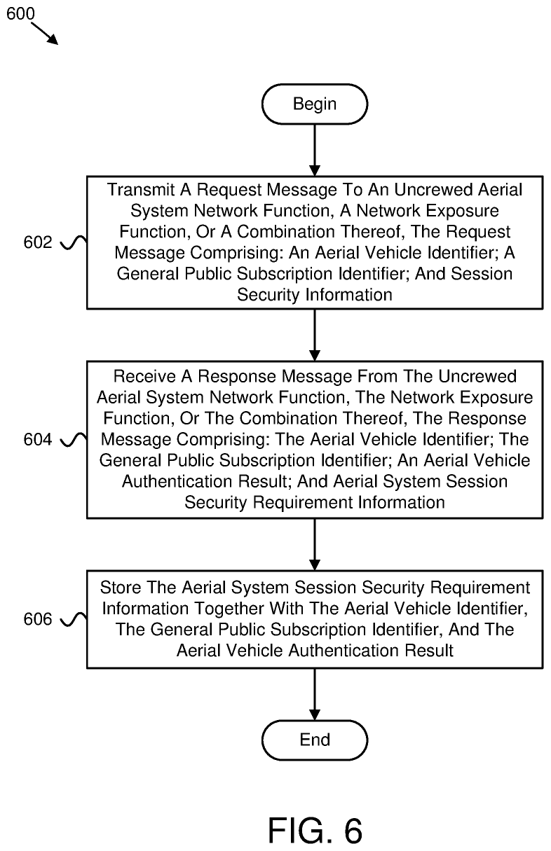

FIG. 6 is a flow chart diagram illustrating one embodiment of a method 600 for communicating and storing aerial system security information. In some embodiments, the method 600 is performed by an apparatus, such as the network unit 104. In certain embodiments, the method 600 may be performed by a processor executing program code, for example, a microcontroller, a microprocessor, a CPU, a GPU, an auxiliary processing unit, a FPGA, or the like.

In various embodiments, the method 600 includes transmitting 602, from a session management function, a request message to an uncrewed aerial system network function, a network exposure function, or a combination thereof, the request message including: an aerial vehicle identifier; a general public subscription identifier; and session security information. In some embodiments, the method 600 includes receiving 604 a response message from the uncrewed aerial system network function, the network exposure function, or the combination thereof, the response message including: the aerial vehicle identifier; the general public subscription identifier; an aerial vehicle authentication result; and aerial system session security requirement information. In certain embodiments, the method 600 includes storing 606 the aerial system session security requirement information together with the aerial vehicle identifier, the general public subscription identifier, and the aerial vehicle authentication result.

In certain embodiments, the method 600 further comprises setting the session security information as supported, enabled, or a combination thereof based on: whether a user plane security policy is required as locally configured; whether the user plane security policy is required as fetched from a unified data management; whether a user equipment integrity protection data rate is valid to apply to the user plane security policy; whether an aerial subscription user plane security policy is required as fetched from the unified data management; or some combination thereof. In some embodiments, the method 600 further comprises setting the session security information as not supported, not preferred, not required, not enabled, or some combination thereof based on: whether a user plane security policy is not needed, is not preferred, or a combination thereof as locally configured; whether the user plane security policy is not needed, is not preferred, or a combination thereof as fetched from a unified data management; whether a user equipment integrity protection data rate is not valid to apply to the user plane security policy; whether there is no aerial subscription user plane security policy or whether the aerial subscription user plane security policy is set as not needed, not preferred, or a combination thereof; or some combination thereof.

In various embodiments, the method 600 further comprises enforcing user plane security based on the aerial system session security requirement information. In one embodiment, the session security information is a user plane security policy, an external user plane security policy, or a combination thereof. In certain embodiments, the aerial system session security requirement information is command and control session security requirement information, user plane data security requirement information, or a combination thereof.

In some embodiments, the aerial system session security requirement information comprises information indicating that user plane security is not required and a cause value indicating that end-to-end security is applicable, supported, or a combination thereof. In various embodiments, the aerial system session security requirement information comprises information indicating that user plane security is required and a cause value indicating that end-to-end security is not applicable, not supported, or a combination thereof. In one embodiment, the method 600 further comprises receiving a user plane security policy from a network function, wherein the user plane security policy comprises an indication of not supported or whether external support is required.

In certain embodiments, the method 600 further comprises setting the session security information, a user plane security policy, or a combination thereof as not supported, not preferred, not required, not enabled, or some combination thereof based on: whether a user plane security policy is required as locally configured; whether the user plane security policy is required as fetched from a home subscribing server; whether a service is related to aerial system communication; whether the session management function determines to invoke aerial vehicle authentication; whether the session management function determines to invoke command and control pairing authorization; whether the session management function handles a connection establishment, a connection modification, or a combination thereof; or some combination thereof. In some embodiments, the session management function is part of an evolved packet system network and is implemented by a combination of the session management function and a packet data network gateway core.

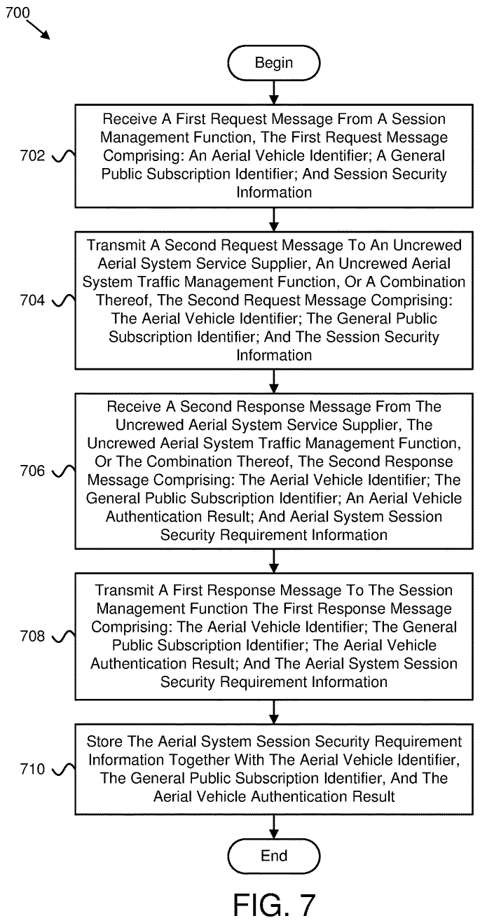

FIG. 7 is a flow chart diagram illustrating another embodiment of a method 700 for communicating and storing aerial system security information. In some embodiments, the method 700 is performed by an apparatus, such as the network unit 104. In certain embodiments, the method 700 may be performed by a processor executing program code, for example, a microcontroller, a microprocessor, a CPU, a GPU, an auxiliary processing unit, a FPGA, or the like.

In various embodiments, the method 700 includes receiving 702, at an uncrewed aerial system network function, a network exposure function, or a combination thereof, a first request message from a session management function, the first request message including: an aerial vehicle identifier; a general public subscription identifier; and session security information. In some embodiments, the method 700 includes transmitting 704 a second request message to an uncrewed aerial system service supplier, an uncrewed aerial system traffic management function, or a combination thereof, the second request message including: the aerial vehicle identifier; the general public subscription identifier; and the session security information. In certain embodiments, the method 700 includes receiving 706 a second response message from the uncrewed aerial system service supplier, the uncrewed aerial system traffic management function, or the combination thereof, the second response message including: the aerial vehicle identifier; the general public subscription identifier; an aerial vehicle authentication result; and aerial system session security requirement information. In various embodiments, the method 700 includes transmitting 708 a first response message to the session management function the first response message including: the aerial vehicle identifier; the general public subscription identifier; the aerial vehicle authentication result; and the aerial system session security requirement information. In some embodiments, the method 700 includes storing 710 the aerial system session security requirement information together with the aerial vehicle identifier, the general public subscription identifier, and the aerial vehicle authentication result.

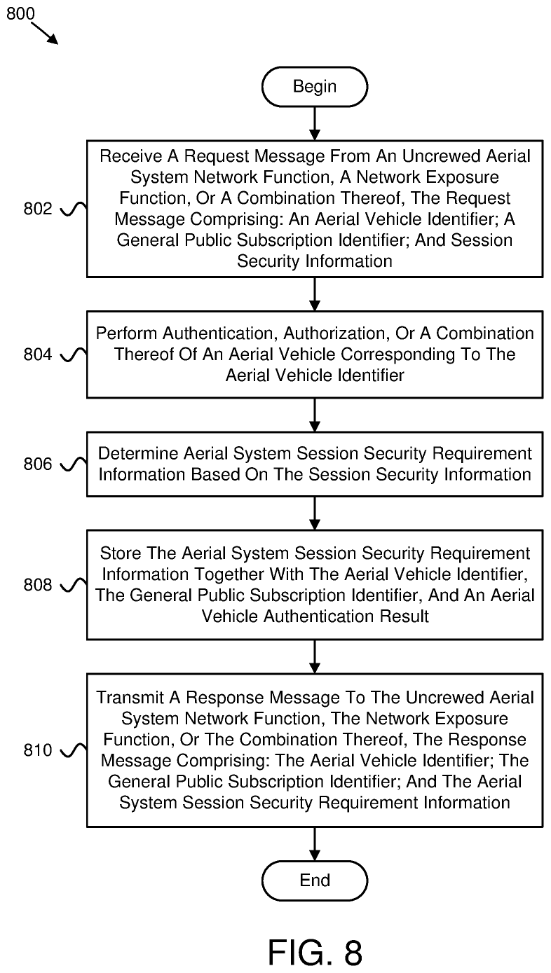

FIG. 8 is a flow chart diagram illustrating a further embodiment of a method 800 for communicating and storing aerial system security information. In some embodiments, the method 800 is performed by an apparatus, such as the network unit 104. In certain embodiments, the method 800 may be performed by a processor executing program code, for example, a microcontroller, a microprocessor, a CPU, a GPU, an auxiliary processing unit, a FPGA, or the like.

In various embodiments, the method 800 includes receiving 802, at an uncrewed aerial system service supplier, an uncrewed aerial system traffic management function, or a combination thereof, a request message from an uncrewed aerial system network function, a network exposure function, or a combination thereof, the request message including: an aerial vehicle identifier; a general public subscription identifier; and session security information. In some embodiments, the method 800 includes performing 804 authentication, authorization, or a combination thereof of an aerial vehicle corresponding to the aerial vehicle identifier. In certain embodiments, the method 800 includes determining 806 aerial system session security requirement information based on the session security information. In various embodiments, the method 800 includes storing 808 the aerial system session security requirement information together with the aerial vehicle identifier, the general public subscription identifier, and an aerial vehicle authentication result. In some embodiments, the method 800 includes transmitting 810 a response message to the uncrewed aerial system network function, the network exposure function, or the combination thereof, the response message including: the aerial vehicle identifier; the general public subscription identifier; and the aerial system session security requirement information.

In certain embodiments, the method 800 further comprises setting the aerial system session security requirement information as required based on: whether the session security information, a user plane security policy, or a combination thereof is indicated as supported or enabled; whether the uncrewed aerial system service supplier, the uncrewed aerial system traffic management function, or the combination thereof determines to apply end-to-end security for session data, user plane data, or a combination thereof; or a combination thereof. In some embodiments, the method 800 further comprises transmitting a cause value indicating that end-to-end security is not applicable, not supported, or a combination thereof.

In various embodiments, the method 800 further comprises setting the aerial system session security requirement information as not required based on: whether the session security information, a user plane security policy, or a combination thereof is indicated as not supported, not enabled, not needed, not preferred, or a combination thereof; whether the uncrewed aerial system service supplier, the uncrewed aerial system traffic management function, or the combination thereof determines to apply end-to-end security for session, data, user plane data, or a combination thereof, or a combination thereof. In one embodiment, the method 800 further comprises transmitting a cause value indicating that end-to-end security is applicable, supported or a combination thereof.

In one embodiment, a method of a session management function comprises: transmitting a request message to an uncrewed aerial system network function, a network exposure function, or a combination thereof, the request message comprising: an aerial vehicle identifier; a general public subscription identifier; and session security information; receiving a response message from the uncrewed aerial system network function, the network exposure function, or the combination thereof, the response message comprising: the aerial vehicle identifier; the general public subscription identifier; an aerial vehicle authentication result; and aerial system session security requirement information; and storing the aerial system session security requirement information together with the aerial vehicle identifier, the general public subscription identifier, and the aerial vehicle authentication result.

In certain embodiments, the method further comprises setting the session security information as supported, enabled, or a combination thereof based on: whether a user plane security policy is required as locally configured; whether the user plane security policy is required as fetched from a unified data management; whether a user equipment integrity protection data rate is valid to apply to the user plane security policy; whether an aerial subscription user plane security policy is required as fetched from the unified data management; or some combination thereof.

In some embodiments, the method further comprises setting the session security information as not supported, not preferred, not required, not enabled, or some combination thereof based on: whether a user plane security policy is not needed, is not preferred, or a combination thereof as locally configured; whether the user plane security policy is not needed, is not preferred, or a combination thereof as fetched from a unified data management; whether a user equipment integrity protection data rate is not valid to apply to the user plane security policy; whether there is no aerial subscription user plane security policy or whether the aerial subscription user plane security policy is set as not needed, not preferred, or a combination thereof; or some combination thereof.

In various embodiments, the method further comprises enforcing user plane security based on the aerial system session security requirement information.

In one embodiment, the session security information is a user plane security policy, an external user plane security policy, or a combination thereof.

In certain embodiments, the aerial system session security requirement information is command and control session security requirement information, user plane data security requirement information, or a combination thereof.

In some embodiments, the aerial system session security requirement information comprises information indicating that user plane security is not required and a cause value indicating that end-to-end security is applicable, supported, or a combination thereof.

In various embodiments, the aerial system session security requirement information comprises information indicating that user plane security is required and a cause value indicating that end-to-end security is not applicable, not supported, or a combination thereof.

In one embodiment, the method further comprises receiving a user plane security policy from a network function, wherein the user plane security policy comprises an indication of not supported or whether external support is required.

In certain embodiments, the method further comprises setting the session security information, a user plane security policy, or a combination thereof as not supported, not preferred, not required, not enabled, or some combination thereof based on: whether a user plane security policy is required as locally configured; whether the user plane security policy is required as fetched from a home subscribing server; whether a service is related to aerial system communication; whether the session management function determines to invoke aerial vehicle authentication; whether the session management function determines to invoke command and control pairing authorization; whether the session management function handles a connection establishment, a connection modification, or a combination thereof; or some combination thereof.

In some embodiments, the session management function is part of an evolved packet system network and is implemented by a combination of the session management function and a packet data network gateway core.

In one embodiment, an apparatus comprises a session management function. The apparatus further comprises: a transmitter that transmits a request message to an uncrewed aerial system network function, a network exposure function, or a combination thereof, the request message comprising: an aerial vehicle identifier; a general public subscription identifier; and session security information; a receiver that receives a response message from the uncrewed aerial system network function, the network exposure function, or the combination thereof, the response message comprising: the aerial vehicle identifier; the general public subscription identifier; an aerial vehicle authentication result; and aerial system session security requirement information; and a processor that stores the aerial system session security requirement information together with the aerial vehicle identifier, the general public subscription identifier, and the aerial vehicle authentication result.

In certain embodiments, the processor sets the session security information as supported, enabled, or a combination thereof based on: whether a user plane security policy is required as locally configured; whether the user plane security policy is required as fetched from a unified data management; whether a user equipment integrity protection data rate is valid to apply to the user plane security policy; whether an aerial subscription user plane security policy is required as fetched from the unified data management; or some combination thereof.

In some embodiments, the processor sets the session security information as not supported, not preferred, not required, not enabled, or some combination thereof based on: whether a user plane security policy is not needed, is not preferred, or a combination thereof as locally configured; whether the user plane security policy is not needed, is not preferred, or a combination thereof as fetched from a unified data management; whether a user equipment integrity protection data rate is not valid to apply to the user plane security policy; whether there is no aerial subscription user plane security policy or whether the aerial subscription user plane security policy is set as not needed, not preferred, or a combination thereof; or some combination thereof.

In various embodiments, the processor enforces user plane security based on the aerial system session security requirement information.

In one embodiment, the session security information is a user plane security policy, an external user plane security policy, or a combination thereof.

In certain embodiments, the aerial system session security requirement information is command and control session security requirement information, user plane data security requirement information, or a combination thereof.

In some embodiments, the aerial system session security requirement information comprises information indicating that user plane security is not required and a cause value indicating that end-to-end security is applicable, supported, or a combination thereof.

In various embodiments, the aerial system session security requirement information comprises information indicating that user plane security is required and a cause value indicating that end-to-end security is not applicable, not supported, or a combination thereof.

In one embodiment, the receiver receives a user plane security policy from a network function, and the user plane security policy comprises an indication of not supported or whether external support is required.

In certain embodiments, the processor sets the session security information, a user plane security policy, or a combination thereof as not supported, not preferred, not required, not enabled, or some combination thereof based on: whether a user plane security policy is required as locally configured; whether the user plane security policy is required as fetched from a home subscribing server; whether a service is related to aerial system communication; whether the session management function determines to invoke aerial vehicle authentication; whether the session management function determines to invoke command and control pairing authorization; whether the session management function handles a connection establishment, a connection modification, or a combination thereof; or some combination thereof.

In some embodiments, the session management function is part of an evolved packet system network and is implemented by a combination of the session management function and a packet data network gateway core.

In one embodiment, a method of an uncrewed aerial system network function, a network exposure function, or a combination thereof comprises: receiving a first request message from a session management function, the first request message comprising: an aerial vehicle identifier; a general public subscription identifier; and session security information; transmitting a second request message to an uncrewed aerial system service supplier, an uncrewed aerial system traffic management function, or a combination thereof, the second request message comprising: the aerial vehicle identifier; the general public subscription identifier; and the session security information; receiving a second response message from the uncrewed aerial system service supplier, the uncrewed aerial system traffic management function, or the combination thereof, the second response message comprising: the aerial vehicle identifier; the general public subscription identifier; an aerial vehicle authentication result; and aerial system session security requirement information; transmitting a first response message to the session management function the first response message comprising: the aerial vehicle identifier; the general public subscription identifier; the aerial vehicle authentication result; and the aerial system session security requirement information; and storing the aerial system session security requirement information together with the aerial vehicle identifier, the general public subscription identifier, and the aerial vehicle authentication result.

In one embodiment, an apparatus comprises an uncrewed aerial system network function, a network exposure function, or a combination thereof. The apparatus further comprises: a receiver that receives a first request message from a session management function, the first request message comprising: an aerial vehicle identifier; a general public subscription identifier; and session security information; a transmitter that transmits a second request message to an uncrewed aerial system service supplier, an uncrewed aerial system traffic management function, or a combination thereof, the second request message comprising: the aerial vehicle identifier; the general public subscription identifier; and the session security information; and a processor, wherein: the receiver receives a second response message from the uncrewed aerial system service supplier, the uncrewed aerial system traffic management function, or the combination thereof, the second response message comprising: the aerial vehicle identifier; the general public subscription identifier; an aerial vehicle authentication result; and aerial system session security requirement information; the transmitter transmits a first response message to the session management function the first response message comprising: the aerial vehicle identifier; the general public subscription identifier; the aerial vehicle authentication result; and the aerial system session security requirement information; and the processor stores the aerial system session security requirement information together with the aerial vehicle identifier, the general public subscription identifier, and the aerial vehicle authentication result.

In one embodiment, a method of an uncrewed aerial system service supplier, an uncrewed aerial system traffic management function, or a combination thereof comprises: receiving a request message from an uncrewed aerial system network function, a network exposure function, or a combination thereof, the request message comprising: an aerial vehicle identifier; a general public subscription identifier; and session security information; performing authentication, authorization, or a combination thereof of an aerial vehicle corresponding to the aerial vehicle identifier; determining aerial system session security requirement information based on the session security information; storing the aerial system session security requirement information together with the aerial vehicle identifier, the general public subscription identifier, and an aerial vehicle authentication result; and transmitting a response message to the uncrewed aerial system network function, the network exposure function, or the combination thereof, the response message comprising: the aerial vehicle identifier; the general public subscription identifier; and the aerial system session security requirement information.

In certain embodiments, the method further comprises setting the aerial system session security requirement information as required based on: whether the session security information, a user plane security policy, or a combination thereof is indicated as supported or enabled; whether the uncrewed aerial system service supplier, the uncrewed aerial system traffic management function, or the combination thereof determines to apply end-to-end security for session data, user plane data, or a combination thereof; or a combination thereof.

In some embodiments, the method further comprises transmitting a cause value indicating that end-to-end security is not applicable, not supported, or a combination thereof.

In various embodiments, the method further comprises setting the aerial system session security requirement information as not required based on: whether the session security information, a user plane security policy, or a combination thereof is indicated as not supported, not enabled, not needed, not preferred, or a combination thereof; whether the uncrewed aerial system service supplier, the uncrewed aerial system traffic management function, or the combination thereof determines to apply end-to-end security for session, data, user plane data, or a combination thereof; or a combination thereof.

In one embodiment, the method further comprises transmitting a cause value indicating that end-to-end security is applicable, supported or a combination thereof.

In one embodiment, an apparatus comprises an uncrewed aerial system service supplier, an uncrewed aerial system traffic management function, or a combination thereof. The apparatus further comprises: a receiver that receives a request message from an uncrewed aerial system network function, a network exposure function, or a combination thereof, the request message comprising: an aerial vehicle identifier; a general public subscription identifier; and session security information; a processor that: performs authentication, authorization, or a combination thereof of an aerial vehicle corresponding to the aerial vehicle identifier; determines aerial system session security requirement information based on the session security information; and stores the aerial system session security requirement information together with the aerial vehicle identifier, the general public subscription identifier, and an aerial vehicle authentication result; and a transmitter that transmits a response message to the uncrewed aerial system network function, the network exposure function, or the combination thereof, the response message comprising: the aerial vehicle identifier; the general public subscription identifier; and the aerial system session security requirement information.

In certain embodiments, the processor sets the aerial system session security requirement information as required based on: whether the session security information, a user plane security policy, or a combination thereof is indicated as supported or enabled; whether the uncrewed aerial system service supplier, the uncrewed aerial system traffic management function, or the combination thereof determines to apply end-to-end security for session data, user plane data, or a combination thereof; or a combination thereof.

In some embodiments, the transmitter transmits a cause value indicating that end-to-end security is not applicable, not supported, or a combination thereof.

In various embodiments, the processor sets the aerial system session security requirement information as not required based on: whether the session security information, a user plane security policy, or a combination thereof is indicated as not supported, not enabled, not needed, not preferred, or a combination thereof; whether the uncrewed aerial system service supplier, the uncrewed aerial system traffic management function, or the combination thereof determines to apply end-to-end security for session, data, user plane data, or a combination thereof; or a combination thereof.

In one embodiment, the transmitter transmits a cause value indicating that end-to-end security is applicable, supported or a combination thereof.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus for performing a network function, the apparatus comprising:
at least one memory; and
at least one processor coupled with the at least one memory and configured to cause the apparatus to:
transmit a request message to an uncrewed aerial system network function, a network exposure function, or a combination thereof, wherein the request message comprises an aerial vehicle identifier (ID), a public subscription ID, and session security information;
receive a response message from the uncrewed aerial system network function, the network exposure function, or the combination thereof, wherein the response message comprises the aerial vehicle ID, the public subscription ID, an aerial vehicle authentication result, and aerial system session security requirement information; and
store the aerial system session security requirement information, the aerial vehicle ID, the public subscription ID, and the aerial vehicle authentication result.

2. The apparatus of claim 1, wherein the at least one processor is configured to cause the apparatus to set sets the session security information as supported, enabled, or a combination thereof based on:
whether a user plane security policy is required as locally configured;
whether the user plane security policy is required as fetched from a unified data management (UDM);
whether a user equipment (UE) integrity protection data rate is valid to apply to the user plane security policy;
whether an aerial subscription user plane security policy is required as fetched from the UDM;
or a combination thereof.

3. The apparatus of claim 1, wherein the at least one processor is configured to cause the apparatus to set sets the session security information as not supported, not preferred, not required, not enabled, or a combination thereof based on:
whether a user plane security policy is not needed, is not preferred, or a combination thereof as locally configured;
whether the user plane security policy is not needed, is not preferred, or a combination thereof as fetched from a unified data management (UDM);
whether a user equipment (UE) integrity protection data rate is not valid to apply to the user plane security policy;
whether there is no aerial subscription user plane security policy or whether the aerial subscription user plane security policy is set as not needed, not preferred, or a combination thereof;
or a combination thereof.

4. The apparatus of claim 1, wherein the at least one processor is configured to cause the apparatus to enforce user plane security based on the aerial system session security requirement information.

5. The apparatus of claim 4, wherein the session security information is a user plane security policy, an external user plane security policy, or a combination thereof.

6. The apparatus of claim 5, wherein the aerial system session security requirement information is command and control session security requirement information, user plane data security requirement information, or a combination thereof.

7. The apparatus of claim 6, wherein the aerial system session security requirement information comprises information indicating that user plane security is not required and a cause value indicating that end-to-end security is applicable, supported, or a combination thereof.

8. The apparatus of claim 7, wherein the aerial system session security requirement information comprises information indicating that user plane security is required and a cause value indicating that end-to-end security is not applicable, not supported, or a combination thereof.

9. The apparatus of claim 8, wherein the at least one processor is configured to cause the apparatus to receive a user plane security policy from a network function, and the user plane security policy comprises an indication of not supported or whether external support is required.

10. The apparatus of claim 9, wherein the at least one processor is configured to cause the apparatus to set the session security information, a user plane security policy, or a combination thereof as not supported, not preferred, not required, not enabled, or a combination thereof based on:
whether a user plane security policy is required as locally configured;
whether the user plane security policy is required as fetched from a home subscribing server;
whether a service is related to aerial system communication;
whether the network function determines to invoke aerial vehicle authentication;
whether the network function determines to invoke command and control pairing authorization;
whether the network function handles a connection establishment, a connection modification, or a combination thereof;
or a combination thereof.

11. The apparatus of claim 10, wherein the network function is part of an evolved packet system network and is implemented by a combination of a session management function (SMF) and a packet data network gateway core.

12. An apparatus for performing a network function, the apparatus comprising:
at least one memory; and
at least one processor coupled with the at least one memory and configured to cause the apparatus to:
receive a first request message from a session management function (SMF), wherein the first request message comprises an aerial vehicle identifier (ID), a public subscription ID, and session security information;
transmit a second request message to an uncrewed aerial system service supplier, an uncrewed aerial system traffic management function, or a combination thereof, wherein the second request message comprises the aerial vehicle ID, the public subscription identifier ID, and the session security information;
receive a second response message from the uncrewed aerial system service supplier, the uncrewed aerial system traffic management function, or the combination thereof, wherein the second response message comprises the aerial vehicle ID, the public subscription ID, an aerial vehicle authentication result, and aerial system session security requirement information;
transmit a first response message to the SMF, wherein the first response message comprises the aerial vehicle ID, the public subscription ID, the aerial vehicle authentication result, and the aerial system session security requirement information; and
store the aerial system session security requirement information, the aerial vehicle ID, the public subscription ID, and the aerial vehicle authentication result.

13. A method of performing a network function, the method comprising:
receiving a request message from a session management function (SMF), wherein the request message comprises an aerial vehicle identifier (ID), a public subscription ID, and session security information;
performing authentication, authorization, or a combination thereof of an aerial vehicle corresponding to the aerial vehicle ID;
determining aerial system session security requirement information based on the session security information;
storing the aerial system session security requirement information together with the aerial vehicle ID, the public subscription ID, and an aerial vehicle authentication result; and
transmitting a response message to an uncrewed aerial system network function, a network exposure function, or the combination thereof, wherein the response message comprises the aerial vehicle ID, the public subscription ID, an aerial vehicle authentication result, and aerial system session security requirement information.

14. The method of claim 13, further comprising:
setting the aerial system session security requirement information as required based on:
whether the session security information, a user plane security policy, or a combination thereof is indicated as supported or enabled;
whether an uncrewed aerial system service supplier, an uncrewed aerial system traffic management function, or the combination thereof determines to apply end-to-end security for session data, user plane data, or a combination thereof;
or a combination thereof; and
transmitting a cause value indicating that end-to-end security is not applicable, not supported, or a combination thereof.

15. The method of claim 13, further comprising:
setting the aerial system session security requirement information as not required based on:
whether the session security information, a user plane security policy, or a combination thereof is indicated as not supported, not enabled, not needed, not preferred, or a combination thereof;
whether an uncrewed aerial system service supplier, an uncrewed aerial system traffic management function, or the combination thereof determines to apply end-to-end security for session, data, user plane data, or a combination thereof;
or a combination thereof; and
transmitting a cause value indicating that end-to-end security is applicable, supported or a combination thereof.

16. A method of performing a network function, the method comprising:
transmitting a request message to an uncrewed aerial system network function, a network exposure function, or a combination thereof, wherein the request message comprises an aerial vehicle identifier (ID), a public subscription ID, and session security information;
receiving a response message from the uncrewed aerial system network function, the network exposure function, or the combination thereof, wherein the response message comprises the aerial vehicle ID, the public subscription ID, an aerial vehicle authentication result, and aerial system session security requirement information; and
storing the aerial system session security requirement information, the aerial vehicle ID, the public subscription ID, and the aerial vehicle authentication result.

17. The method of claim 16, wherein setting the session security information as supported, enabled, or a combination thereof is based on:
whether a user plane security policy is required as locally configured;
whether the user plane security policy is required as fetched from a unified data management (UDM);
whether a user equipment (UE) integrity protection data rate is valid to apply to the user plane security policy;
whether an aerial subscription user plane security policy is required as fetched from the UDM;
or a combination thereof.

18. The method of claim 16, wherein setting the session security information as not supported, not preferred, not required, not enabled, or a combination thereof is based on:
whether a user plane security policy is not needed, is not preferred, or a combination thereof as locally configured;
whether the user plane security policy is not needed, is not preferred, or a combination thereof as fetched from a unified data management (UDM);
whether a user equipment (UE) integrity protection data rate is not valid to apply to the user plane security policy;
whether there is no aerial subscription user plane security policy or whether the aerial subscription user plane security policy is set as not needed, not preferred, or a combination thereof;
or a combination thereof.

19. The method of claim 18, wherein enforcing user plane security is based on the aerial system session security requirement information.

20. The method of claim 19, wherein the session security information is a user plane security policy, an external user plane security policy, or a combination thereof.
